(19) United States
(12) Patent Application Publication
(10) Pub. No.: US 2014/0250407 A1
(43) Pub. Date: Sep. 4, 2014

(54) METHOD, APPARATUS AND COMPUTER READABLE STORAGE MEDIUM FOR DISPLAYING SIDEBAR INFORMATION

(71) Applicant: TENCENT TECHNOLOGY (SHENZHEN) COMPANY LIMITED, Shenzhen (CN)

(72) Inventors: Bo HU, Shenzhen (CN); Ying HUANG, Shenzhen (CN); Tingyong TANG, Shenzhen (CN); Renfang LIU, Shenzhen (CN); Zhipei WANG, Shenzhen (CN); Ruiyi ZHOU, Shenzhen (CN); Xi WANG, Shenzhen (CN); Zhengkai XIE, Shenzhen (CN); Wei LI, Shenzhen (CN); Cheng FENG, Shenzhen (CN); Kai ZHANG, Shenzhen (CN); Huijiao YANG, Shenzhen (CN)

(73) Assignee: TENCENT TECHNOLOGY (SHENZHEN) COMPANY LIMITED, Shenzhen (CN)

(21) Appl. No.: 14/247,862

(22) Filed: Apr. 8, 2014

Related U.S. Application Data
(63) Continuation of application No. PCT/CN2013/088462, filed on Dec. 3, 2013.

(30) Foreign Application Priority Data
Mar. 4, 2013 (CN) 201310068941.4

(51) Int. Cl. G06F 3/0481

(52) U.S. Cl. CPC G06F 3/0481
USPC 715/781

(57) ABSTRACT

Embodiments of the present disclosure disclose a method, apparatus and computer readable storage medium for displaying sidebar information, relate to the field of information technology, and improve the display accuracy of the sidebar information. The method includes: first obtaining an operation trail on a screen interface; then determining whether the operation trail is an operation trail to trigger displaying the sidebar information; if the operation trail is the operation trail to trigger displaying the sidebar information, displaying or playing a piece of prompt information for confirming whether to display the sidebar information; finally receiving a confirmation operation for displaying the sidebar information and displaying the sidebar information on the screen interface.

### CROSS-REFERENCES TO RELATED APPLICATIONS

This application is a continuation of International Application No. PCT/CN2013/088462, filed on Dec. 5, 2013, which claims priority to Chinese patent application No. CN201310068941.4 named “Method and Apparatus for Displaying Sidebar Information” and filed on Mar. 4, 2013, the content of which is incorporated herein by reference in their entirety.

### TECHNICAL FIELD

The present disclosure relates to the field of information technology, and particularly to a method, apparatus and computer readable storage medium for displaying sidebar information.

### BACKGROUND

With the continuous development of terminal devices, the functions of the terminal devices become more and more rich. When an application program runs in a terminal device, due to the restriction of the area of the screen interface, especially for example the small area of the screen interface of mobile terminal devices such as cell phones, notebooks, etc, the content that can be displayed by the screen interface is limited during a user reads and uses the terminal devices. In order to enable the screen interface to be maximized for displaying content, a hidden area which can carry functions and operations needs to be configured.

Currently, an area that can be expanded from the right and left edges of the screen interface of a terminal device is usually used to carry a hidden function. That is, a hidden function is displayed in a manner of sidebar. As long as the terminal device determines and confirms that there exists an operation trail at the edge of the screen interface, it generates and displays the sidebar information.

### SUMMARY OF THE DISCLOSURE

However, the above-mentioned operation trail at the edge of the screen interface is not necessarily the operation trail that the user instructs displaying the sidebar information. In other words, the above-mentioned operation trail may be an operation trail generated by the user's mistaken operation at the edge of the screen interface. If the terminal device still displays the sidebar information at this point, the display accuracy of the existing sidebar information would be caused to be low.

The embodiments of the present disclosure provide a method, apparatus and computer readable storage medium for displaying sidebar information, which improves the display accuracy of the sidebar information.

According to a first aspect of the present disclosure, there is provided a method for displaying sidebar information, comprising: obtaining an operation trail on a screen interface; determining whether the operation trail is an operation trail to trigger displaying the sidebar information; if the operation trail is the operation trail to trigger displaying the sidebar information, displaying or playing a piece of prompt information for confirming whether to display the sidebar information; receiving a confirmation operation for displaying the sidebar information; and displaying the sidebar information on the screen interface.

According to a second aspect of the present disclosure, there is provided an apparatus for displaying sidebar information, comprising: an obtaining unit configured to obtain an operation trail on a screen interface; a determining unit configured to determine whether the operation trail obtained by the obtaining unit is an operation trail to trigger displaying the sidebar information; a displaying and playing unit configured to display or play a piece of prompt information for confirming whether to display the sidebar information if the determining unit determines that the operation trail is the operation trail to trigger displaying the sidebar information; and a receiving unit configured to receive a confirmation operation for displaying the sidebar information, wherein the displaying and playing unit is further configured to display the sidebar information on the screen interface after the receiving unit receives the confirmation operation for displaying the sidebar information.

According to a third aspect of the present disclosure, there is provided a computer readable storage medium having stored thereon a computer program containing a program code, which, when executed on a computing device, performs respective steps of the method for displaying sidebar information according to the first aspect of the present disclosure.

Compared with the prior art in which the sidebar information is generated and displayed as long as it is determined and confirmed that there is an operation trail at the edge of the screen interface, the method, apparatus and computer readable storage medium for displaying sidebar information provided by the embodiments of the present disclosure avoids the technological problem of displaying the sidebar information due to the user's mistaken operation and improves the display accuracy of the sidebar information by a manner of double confirmation in which when the terminal device determines and confirms that there is an operation trail at the edge of the screen interface, a piece of prompt information is first displayed or played, and then the sidebar information is displayed after a confirmation operation for displaying the sidebar information is received.

### BRIEF DESCRIPTION OF THE DRAWINGS

In order to explain technical solutions in embodiments of the present disclosure more clearly, simple introduction of attached drawings needed to be used in the description of embodiments will be given below. Apparently, the attached drawings in the description below are only some embodiments of the present disclosure. For those ordinary skilled in the art, other attached drawings can be obtained according to these attached drawings without inventive efforts.

FIG. 1 is a flowchart of a method for displaying sidebar information provided in an embodiment of the present disclosure;

FIG. 2 is a flowchart of another method for displaying sidebar information provided in an embodiment of the present disclosure;

FIG. 3 is a structural schematic diagram of an apparatus for displaying sidebar information provided in an embodiment of the present disclosure;

FIG. 4 is a structural schematic diagram of another apparatus for displaying sidebar information provided in an embodiment of the present disclosure;

FIG. 5 is a schematic diagram of a preset pattern displaying provided in an embodiment of the present disclosure;

FIG. 6 is a schematic diagram of another preset pattern displaying provided in an embodiment of the present disclosure; and

FIG. 7 is a structural schematic diagram showing an example terminal device which can be used to implement respective embodiments of the present disclosure.

### DETAILED DESCRIPTION

The technical solutions in the embodiments of the present disclosure will be clearly and completely described in conjunction with attached drawings in the embodiments of the present disclosure below. Obviously, the described embodiment is only part but not all of the embodiments of present disclosure. All other embodiments obtained by those ordinary skilled in the art based on the embodiments in the present disclosure without creative work fall into the protection scope of the present disclosure.

In order to make the advantages of the technical solutions of the present disclosure more clear, a detailed description of the present disclosure will be made in conjunction with attached drawings and embodiments below.

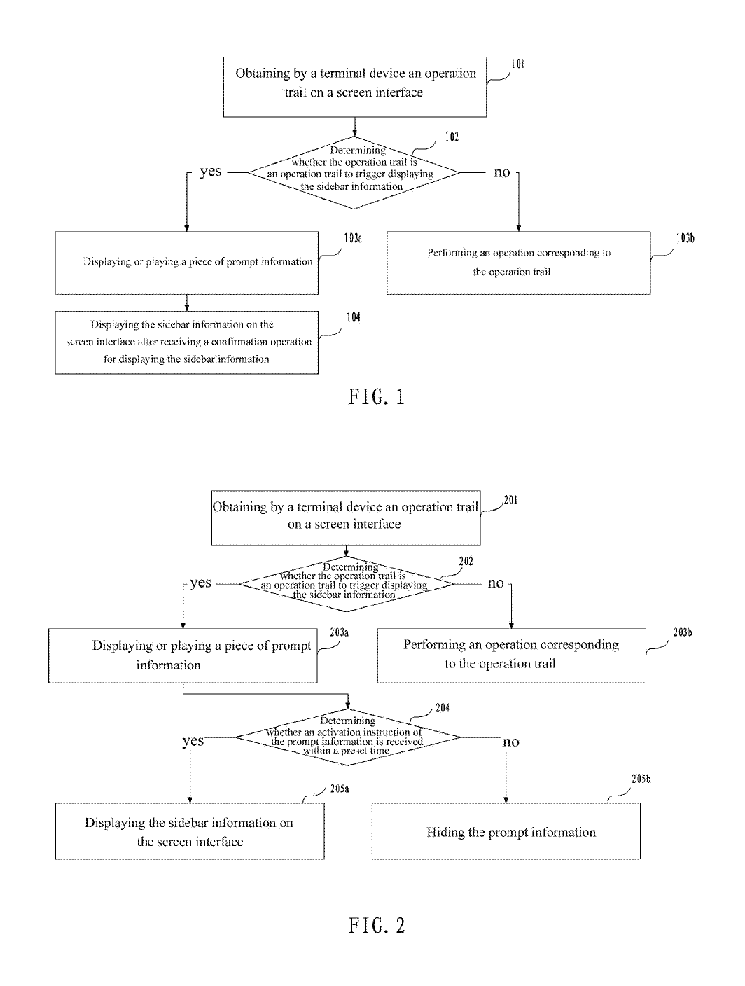

An embodiment of the present disclosure provides a method for displaying sidebar information as shown in FIG. 1. The method includes the following steps.

In step 101, a terminal device obtains an operation trail on a screen interface of the terminal device.

If the terminal device is a terminal device with a touch screen such as a touch screen cell phone, a touch screen notebook, etc, the operation trail on the screen interface can be for example a touch trail performed by the user on the screen interface. If the terminal device is not a terminal device with a touch screen such as a computer, the operation trail can be for example a move trail of a cursor on the screen interface when the user performs a dragging operation through an external device such as a mouse.

In step 102, it is determined whether the operation trail is an operation trail to trigger displaying the sidebar information.

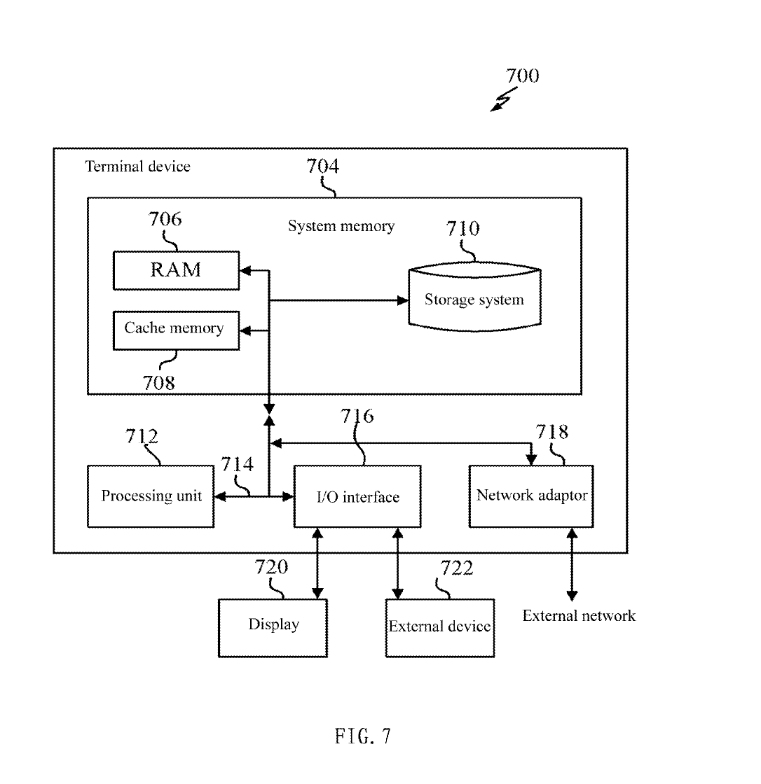

It is noted that when an application window interface is full-screen-displayed in the screen interface, the operation trail to trigger displaying the sidebar information can be for example a move trail from an edge of the screen interface to the center of the screen interface. For example, for a terminal device with a touch screen, if the sidebar information needed to be displayed is a right sidebar, the operation trail to trigger displaying the sidebar information can be for example a touch trail generated by sliding from the right edge of the screen interface to the center of the screen interface. When the application window interface is not full-screen-displayed in the screen interface, as shown in FIG. 6 in which the application window interface is displayed on the screen interface in a manner of thumbnail, the operation trail to trigger displaying the sidebar information can be for example a move trail from an edge of the application window interface to the center of the application window interface. For example, for a terminal device with a touch screen, if the sidebar information needed to be displayed is a left sidebar, the operation trail to trigger displaying the sidebar information can be for example a touch trail generated by sliding from the left edge of the application window interface to the center of the application window interface.

It is noted here that the screen interface in the embodiment preferably refers to a display interface of an application window.

In addition, although the above description is performed by an example in which the operation trail to trigger displaying the sidebar information is a move trail from an edge of the screen interface to the center of the screen interface, the present disclosure is not limited to it. Those skilled in the art can adopt other suitable move trails according to specific applications.

In addition, although the above description is performed by taking the left or right sidebar as an example, the present disclosure is not limited to it. It can be understood by those skilled in the art that the sidebar information can also refers to the information that can be extendedly displayed in a position such as upside or downside of the screen interface or application window.

In step 103a, if the operation trail is the operation trail to trigger displaying the sidebar information, then a piece of prompt information is displayed or played.

Preferably, the prompt information is used for confirming whether to display the sidebar information. In particular, the prompt information can be a preset pattern, audio information, video information, text information or the like, or any combination thereof. The specific type of the prompt information is not limited in the present disclosure. For example, the preset pattern can in particular be a holder with a preset shape, e.g. a circle holder, square holder, etc. The shape of the holder can be arbitrarily configured by the designer. The audio information can in particular be the audio prompt information. The video information can be dynamically prompted by the software with the animated-playing function such as Flash. The text information can be prompted by popping up a text prompt box.

In step 103b, if the operation trail is not the operation trail to trigger displaying the sidebar information, an operation corresponding to the operation trail is performed.

In step 104, after a confirmation operation for displaying the sidebar information is received, the sidebar information is displayed on the screen interface.

The sidebar information can in particular be the extended operation information corresponding to an application program, e.g. content copy, text translation, setting item, account login, customization, etc. The specific implementation of the confirmation operation can be any suitable way in the art, which does not restrict the present disclosure.

Compared with the prior art in which the sidebar information is generated and displayed as long as the terminal device determines and confirms that there is an operation trail at the edge of the screen interface, the method for displaying the sidebar information provided by the embodiment of the present disclosure avoids the technological problem of displaying the sidebar information due to the user's mistaken operation and improves the display accuracy of the sidebar information by a manner of double confirmation in which when the terminal device determines and confirms there is an operation trail at the edge of the screen interface, a piece of prompt information is first displayed or played, and then the sidebar information is displayed after a confirmation operation for displaying the sidebar information is received.

Further, an embodiment of the present disclosure provides another method for displaying sidebar information as shown in FIG. 2. The method includes the following steps.

In step 201, a terminal device obtains an operation trail on a screen interface of the terminal device.

If the terminal device is a terminal device with a touch screen such as a touch screen cell phone, a touch screen notebook, etc, the operation trail on the screen interface can be for example a touch trail performed by the user on the screen interface. If the terminal device is not a terminal device with a touch screen such as a computer, the operation trail can be for example a move trail of a cursor on the screen interface when the user performs a dragging operation through an external device such as a mouse.

In step 202, it is determined whether the operation trail is an operation trail to trigger displaying the sidebar information.

It is noted that when an application window interface is full-screen-displayed in the screen interface, the operation trail to trigger displaying the sidebar information can be for example a move trail from an edge of the screen interface to the center of the screen interface. For example, for a terminal device with a touch screen, if the sidebar information needed to be displayed is a right sidebar, the operation trail to trigger displaying the sidebar information can be for example a touch trail generated by sliding from the right edge of the screen interface to the center of the screen interface. When the application window interface is not full-screen-displayed in the screen interface, as shown in FIG. 6 in which the application window interface is displayed on the screen interface in a manner of thumbnail, the operation trail to trigger displaying the sidebar information can be for example a move trail from an edge of the application window interface to the center of the application window interface. For example, for a terminal device with a touch screen, if the sidebar information needed to be displayed is a left sidebar, the operation trail to trigger displaying the sidebar information can be for example a touch trail generated by sliding from the left edge of the application window interface to the center of the application window interface.

It is noted here that the screen interface in the embodiment preferably refers to a display interface of an application window.

In addition, although the above description is performed by an example in which the operation trail to trigger displaying the sidebar information is a move trail from the edge of the screen interface to the center of the screen interface, the present disclosure is not limited to it. Those skilled in the art can adopt other suitable move trails according to specific applications.

In addition, although the above description is performed by taking the left or right sidebar as an example, the present disclosure is not limited to it. It can be understood by those skilled in the art that the sidebar information can also refers to information that can be extendedly displayed in a position such as upside or downside of the screen interface or application window.

In step 203a, if the operation trail is the operation trail to trigger displaying the sidebar information, then a piece of prompt information is displayed or played.

Preferably, the prompt information can include any one of a preset pattern, audio information, video information, text information or the like, or any combination thereof. For example, the preset pattern can in particular be a holder with a preset shape, e.g. a circle holder, square holder, etc. The shape of the holder can be arbitrarily configured by the designer. The audio information can in particular be the audio prompt information. The video information can be dynamically prompted by the software with the animated-playing function such as Flash. The text information can be prompted by popping up a text prompt box.

Preferably, the method can also include, before displaying or playing the prompt information, pre-configuring the prompt information, and then storing the prompt information after associating the prompt information with a pre-configured area on the screen interface.

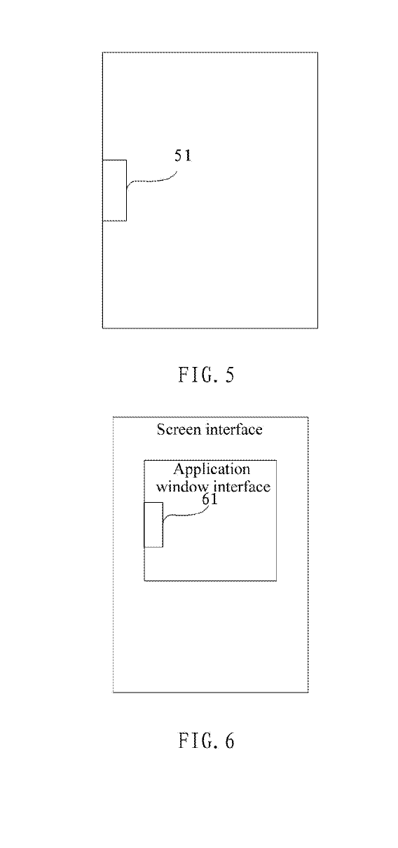

Preferably, the pre-configured area can be configured according to practical situations. For example, if the sidebar information needed to be displayed is on the left side of the screen interface, and the prompt information is the preset pattern, the preset pattern can be associated with some area on the left edge of the screen and then stored. As shown in FIG. 5 in which the rectangle denoted with 51 is the preset pattern, the pre-configured area is chosen to be in the middle of the left edge of the screen interface, and the preset pattern is rectangle.

In step 203b, if the operation trail is not the operation trail to trigger displaying the sidebar information, an operation corresponding to the operation trail is performed.

In step 204, it is determined whether an activation instruction of the prompt information is received within a preset time.

Preferably, the preset time can be configured according to the need of the user. For example, the preset time can be configured to be 1 second, 2 seconds or the like, which is not restricted in the embodiment. If the prompt information is a preset pattern, the activation instruction of the preset pattern can be for example operations such as clicking the preset pattern, dragging the preset pattern or the like. If the prompt information is the audio information, the activation instruction of the audio information can be for example a confirmation operation to the audio prompt information. If the prompt information is the video information, the activation instruction of the video information can be for example a confirmation operation to a dynamic prompt performed by the software with the animated-playing function such as Flash. If the prompt information is the text information, the activation instruction of the text information can be for example a confirmation operation to the popped-up text prompt box. If the prompt information is any combination of the above examples of information, the activation instruction can also be a corresponding combination of the above activation instructions. It is understood by those skilled in the art that the specific implementation of the activation instruction does not restrict the present disclosure.

In step 205a, if the activation instruction of the prompt information is received within a preset time, the sidebar information is displayed on the screen interface.

The sidebar information can in particular be the extended operation information corresponding to an application program, e.g. content copy, text translation, setting item, account login, customization, etc.

In step 205b, if the activation instruction of the prompt information is not received within a preset time, the sidebar information is hidden.

If the activation instruction of the prompt information is not received within a preset time, it means that the user does not need to display the sidebar information. In other words, the user may have mistakenly made the operation. At this point, hiding the prompt information may ensure the fluency of the user's operation, and avoid the technical problem of displaying the sidebar information due to the user's mistaken operation.

For this embodiment, the application scene can for example be that the terminal device is a terminal device with a touch screen, the application window interface is full-screen-displayed on the screen interface, and the process includes: when a user slides on the screen interface from left edge of the screen to the right, the terminal device first determines and confirms that the operation trail is an operation trail to trigger displaying the sidebar information, and then generates a rectangle holder (e.g. the rectangle holder 51 shown in FIG. 5) in the middle of the left edge of the screen; if the user clicks the holder or drags the holder from the left to the right within a short time, the terminal device generates and displays the sidebar information; if the user perform no operation to the holder within a period of time, the terminal device hides the holder, and maintains the operation of the current screen interface, e.g., displaying webpage content, ensuring the fluency of the user's operation, avoiding the technical problem of displaying the sidebar information due to the user's mistaken operation, and improving the display accuracy of the sidebar information. The above period of time can be set according to the user's custom, for example, set as 1 s, 2 s or the like.

For this embodiment, the application scene can also for example be that the terminal device is a terminal device without a touch screen, the application window interface is displayed on the screen interface in manner of thumbnail (i.e., not full-screen-displayed), and the process includes: when a user moves the cursor on the screen interface by dragging a mouse, the terminal device first determines whether there is a cursor moving trail to trigger displaying the sidebar information, and if there is a cursor moving trail to trigger displaying the sidebar information, then generates a rectangle holder (e.g. the rectangle holder 61 shown in FIG. 6) in the middle of the left edge of the application window interface; if the user clicks the holder or drags the holder from the left to the right within a short time, the terminal device displays the sidebar information at the left edge of the application window interface; if the user perform no operation to the holder within a period of time, the terminal device hides the holder, and maintains the operation of the current application window interface, e.g., displaying webpage content, ensuring the fluency of the user's operation, avoiding the technical problem of displaying the sidebar information due to the user's mistaken operation, and improving the display accuracy of the sidebar information. The above period of time can be set according to the user's custom, for example, set as 1 s, 2 s or the like.

The embodiment is not limited to the above application scenes for displaying the sidebar information, and can be applied to other scenes. For example, when a user is browsing a webpage, sliding in the horizontal direction can perform switching between different webpages. However, when a user is browsing some webpage, sliding in the horizontal direction may be performed due to a mistaken operation, i.e., when browsing the webpage content through sliding from top to bottom, resulting in unnecessary switch between webpages and disturbing the continuity of the user's browsing. At this point, the terminal device can first confirm if there is a touch trail to trigger switching between webpages. If it is confirmed that there is a touch trail to trigger switching between webpages, the terminal device generates and displays a holder in a pre-configured area. If the user clicks the holder or drags the holder in the horizontal direction within a short time, the terminal device performs switching between different webpages; if the user perform no operation to the holder within a period of time, the terminal device hides the holder and maintains the operation of the current interface, ensuring the fluency of the user's operation, avoiding the technical problem of displaying the sidebar information due to the user's mistaken operation, and improving the switching accuracy between different webpages.

Compared with the prior art in which the sidebar information is generated and displayed as long as the terminal device determines and confirms that there is an operation trail at the edge of the screen interface, in another method for displaying sidebar information also provided by the embodiment of the present disclosure, the terminal device first configures a target area within which any one operation trail can trigger the terminal device to directly display the sidebar information; then the terminal device obtains the operation trail on the screen interface and determines whether the operation trail is within the target area; if the operation trail is within the target area, the terminal device displays the sidebar information. In such a way, the user configures a target area for directly displaying the sidebar information, such that the user can directly slides a finger, a handwriting pen or the like in the target area when the user needs the sidebar information to be displayed. The sidebar information will not be displayed if the user slides a finger or a handwriting pen outside the target area. Therefore, the fluency of the user's operation is ensured, and it is avoided that the sidebar information is displayed due to the user's mistaken operation, which interrupts the user's browsing.

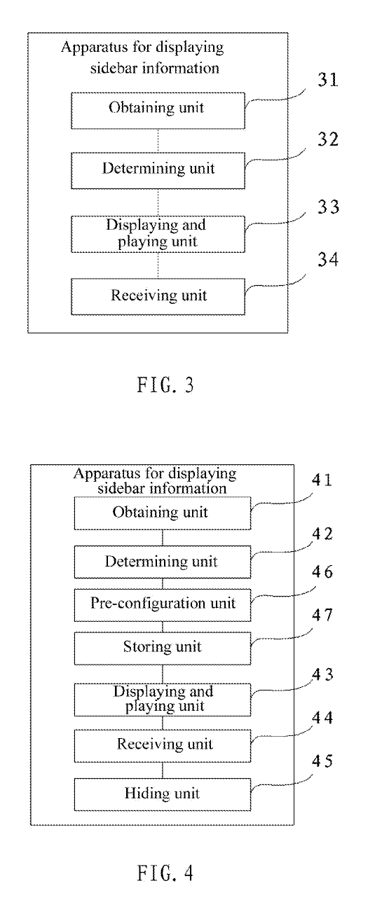

Further, as an implementation of the method embodiment shown in FIG. 1, an embodiment of the present disclosure also provides a display apparatus for displaying the sidebar information to implement the method embodiment shown in FIG. 1. As shown in FIG. 3, the apparatus can be applied in a terminal device such as a cell phone, a notebook, etc. The apparatus includes: an obtaining unit 31, a determining unit 32, a displaying and playing unit 33, and a receiving unit 34.

The obtaining unit 31 can be configured to obtain an operation trail on a screen interface.

The determining unit 32 can be configured to determine whether the operation trail obtained by the obtaining unit 31 is an operation trail to trigger displaying the sidebar information.

The displaying and playing unit 33 can be configured to display or play a piece of prompt information for confirming whether to display the sidebar information if the determining unit 32 determines that the operation trail is the operation trail to trigger displaying the sidebar information.

The receiving unit 34 can be configured to receive a confirmation operation for displaying the sidebar information.

The displaying and playing unit 33 can be further configured to display the sidebar information on the screen interface after the receiving unit 34 receives the confirmation operation for displaying the sidebar information.

Further, as an implementation of the method embodiment shown in FIG. 2, an embodiment of the present disclosure also provides another display apparatus for displaying the sidebar information to implement the method embodiment shown in FIG. 2. As shown in FIG. 4, the apparatus can be applied in a terminal device such as a cell phone, a notebook, etc. The apparatus includes: an obtaining unit 41, a determining unit 42, a displaying and playing unit 43, a receiving unit 44, a hiding unit 45, a pre-configuration unit 46, and a storing unit 47.

The obtaining unit 41 can be configured to obtain an operation trail on a screen interface.

The determining unit 42 can be configured to determine whether the operation trail obtained by the obtaining unit 41 is an operation trail to trigger displaying the sidebar information.

The displaying and playing unit 43 can be configured to display or play a piece of prompt information for confirming whether to display the sidebar information if the determining unit 42 determines that the operation trail is the operation trail to trigger displaying the sidebar information.

The receiving unit 44 can be configured to receive a confirmation operation for displaying the sidebar information.

The displaying and playing unit 43 can be further configured to display the sidebar information on the screen interface after the receiving unit 44 receives the confirmation operation for displaying the sidebar information.

The hiding unit 45 can be configured to hide the prompt information if the activation instruction of the prompt information is not received within a preset time.

The pre-configuration unit 46 can be configured to pre-configure the prompt information.

The storing unit 47 can be configured to store the prompt information pre-configured by the pre-configuration unit 46 after associating the prompt information with a pre-configured area on the screen interface.

It is noted that other corresponding description of the respective functional units involved in the apparatus for displaying sidebar information provided in the embodiments of the present disclosure can reference to the corresponding description in FIGS. 1 and 2, which are not described again here in this embodiment.

Compared with the prior art in which the sidebar information is generated and displayed as long as it is determined and confirmed that there is an operation trail at the edge of the screen interface, the apparatus for displaying sidebar information provided by the embodiments of the present disclosure avoids the technological problem of displaying the sidebar information due to the user's mistaken operation and improves the display accuracy of the sidebar information by a manner of double confirmation in which when the terminal device determines and confirms there is an operation trail at an edge of the screen interface, a piece of prompt information is first displayed or played, and then the sidebar information is displayed after a confirmation operation for displaying the sidebar information is received.

The apparatus for displaying sidebar information provided in the embodiments of the present disclosure can implement the method embodiments provided in the above. The detailed function implementation refers to the description of the method embodiment, which is not described here again. The method and apparatus for displaying sidebar information provided in the embodiments of the present disclosure can be applied to, but is not limited to, the field of information technology.

It can be understood by those ordinary skilled in the art that all or part of steps methods for implementing the above embodiments may be completed by the related hardware instructed by a computer program. The program may be stored in a computer readable storage medium which may be magnetic disk, optical disk, read only memory (ROM), random access memory (RAM) or the like. When the program is executed, it can include flows in the embodiments of the above respective methods.

FIG. 7 is a structural schematic diagram showing an example terminal device which can be used to implement respective embodiments of the present disclosure.

The terminal device 700 shown in FIG. 7 is only an example and is not limiting of the functionality and the scope of use of embodiments of the disclosure. As shown in FIG. 7, the terminal device 700 may be in a form of a general purpose computing device.

Components of the terminal device 700 may include, but are not limited to, one or more processors or processing units 712, a system memory 704, an I/O interface 716, a network adapter 718, a display 720 and a bus 714 that couples various components, and may be connected to an external device 722.

The bus 714 represents one or more of any of several types of bus structures. For example, such bus structures include, but are not limited to, Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus and so on.

The terminal device 700 typically includes a variety of computer system readable media. Such media may be any readable media that is accessible by the terminal device 700, and it includes both volatile and non-volatile media, removable and non-removable media.

The system memory 704 can include readable media in the form of volatile memory, such as random access memory (RAM) 706 and/or cache memory 708. The terminal device 700 may further include other removable/non-removable, volatile/non-volatile storage media. For example, the storage system 710 (typically called a “hard drive”) can be provided for reading from and writing to a non-removable, non-volatile magnetic media. Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus 714 by one or more data media interfaces.

The system memory 704 may include at least one program product having a set (for example, at least one) of program modules which may be stored in the storage system 710. The program module contains a computer executable program instruction. Such program modules are configured to perform functions of respective embodiments of the present disclosure by the processing units 712 executing the program instruction therein. Such program modules include, but are not limited to, an operating system, one or more application programs, other program modules, and program data. Each of these examples of program modules or some combination thereof may include an implementation of a networking environment.

The terminal device 700 may also communicate with one or more external devices 722 such as a keyboard, a mouse, the display 720, etc.; and one or more devices that enable a user to interact with the terminal device 700. Such communication can occur via the Input/Output (I/O) interface 716. Still yet, the terminal device 700 can also communicate with one or more networks such as a local area network (LAN), a general wide area network (WAN), and/or a public network (e.g., the Internet) via the network adapter 718 such as a network card, modem, etc. As shown in FIG. 7, the I/O interface 716 and the network adapter 718 communicates with the other modules of the terminal device 700 via the bus 714. It should be understood that although not shown, other hardware and/or software modules could be used in conjunction with the terminal device 700. Such other hardware and/or software modules include, but are not limited to: microcode, device drivers, redundant processing units, external disk drive arrays, RAID systems, tape drives, and data archival storage systems, etc.

Respective units or steps in respective embodiments of the present disclosure may all be implemented by executing program modules having computer program instructions in the terminal device 700.

The described above is only specific embodiments of the present disclosure and is not intended to limit the protection scope of the present disclosure. Any modification or replacement easily conceived by those skilled in the art within technical scope of the present disclosure should all be contained within the protection scope of the present disclosure. Therefore, the protection scope of the present disclosure is defined by the protection scope of the claims.

What is claimed is:

1. A method for displaying sidebar information, comprising:
obtaining an operation trail on a screen interface;
determining whether the operation trail is an operation trail to trigger displaying the sidebar information;
if the operation trail is the operation trail to trigger displaying the sidebar information, displaying or playing a piece of prompt information for confirming whether to display the sidebar information;
receiving a confirmation operation for displaying the sidebar information; and
displaying the sidebar information on the screen interface.

2. The method for displaying sidebar information according to claim 1, wherein the prompt information comprises any one or any combination of the followings: preset pattern, audio information, video information and text information.

3. The method for displaying sidebar information according to claim 1, wherein the confirmation operation for displaying the sidebar information refers to receiving an activation instruction of the prompt information within a preset time.

4. The method for displaying sidebar information according to claim 3, further comprising:
if the activation instruction of the prompt information is not received within the preset time, hiding the prompt information.

5. The method for displaying sidebar information according to claim 1, further comprising:
pre-configuring the prompt information;
storing the prompt information after associating the prompt information with a pre-configured area on the screen interface.

6. An apparatus for displaying sidebar information, comprising:
an obtaining unit configured to obtain an operation trail on a screen interface;
a determining unit configured to determine whether the operation trail obtained by the obtaining unit is an operation trail to trigger displaying the sidebar information;
a displaying and playing unit configured to display or play a piece of prompt information for confirming whether to display the sidebar information if the determining unit determines that the operation trail is the operation trail to trigger displaying the sidebar information; and
a receiving unit configured to receive a confirmation operation for displaying the sidebar information,
wherein the displaying and playing unit is further configured to display the sidebar information on the screen interface after the receiving unit receives the confirmation operation for displaying the sidebar information.

7. The apparatus for displaying sidebar information according to claim 6, wherein the prompt information comprises any one or any combination of the followings: preset pattern, audio information, video information and text information.

8. The apparatus for displaying sidebar information according to claim 6, wherein the confirmation operation for displaying the sidebar information refers to receiving an activation instruction of the prompt information within a preset time.

9. The apparatus for displaying sidebar information according to claim 8, further comprising:
a hiding unit configured to hide the prompt information if the activation instruction of the prompt information is not received within the preset time.

10. The apparatus for displaying sidebar information according to claim 6, further comprising:
a pre-configuration unit configured to pre-configure the prompt information;
a storing unit configured to store the prompt information pre-configured by the pre-configuration unit after associating the prompt information with a pre-configured area on the screen interface.

11. A computer readable storage medium having stored thereon a computer program containing a program code, which, when executed on a computing device, performs respective steps of the method for displaying sidebar information according to claim 1.
